(19) United States
(12) Patent Application Publication
(10) Pub. No.: US 2004/0071133 A1
(43) Pub. Date: Apr. 15, 2004

(54) Intelligent PPPOE initialization

(75) Inventors: Jon A. Yusko, Raleigh, NC (US); Kraig E. Haglund, Raleigh, NC (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ (US)

(21) Appl. No.: 10/065,393

(22) Filed: Oct. 11, 2002

(51) Int. Cl. H04L 12/66

(52) U.S. Cl. 370/356

(57) ABSTRACT

An exemplary mechanism for intelligent Point-to-Point Protocol over Ethernet (PPPoE) initialization is disclosed herein. During the PPPoE discovery stage, a PPPoE client of a CPE determines the status of a connection between the CPE and an access concentrator prior to transmitting a PADI and/or PADR packet. If a physical layer connection is established, the PPPoE client can provide the packet to the physical interface for transmission to the access concentrator. If a physical layer connection is not established, the PPPoE client either periodically rechecks the status of the connection until a physical layer connection is established or the PPPoE can terminate the PPPoE discovery stage after a certain number of iterations. Additionally, prior to waiting for a PADO or PADS packet, the PPPoE client can be adapted to check the status of the connection. If a physical layer connection exists, the PPPoE client can initiate the wait for the packet. However, if a physical layer connection has not been established, the PPPoE client can either reattempt a previous step of the PPPoE discovery stage or terminate the PPPoE discovery stage.

### BACKGROUND OF THE INVENTION

The present invention relates generally to the use of the Point-to-Point Protocol (PPP) to transport data over a physical link. More particularly, the invention relates to the initialization of a PPP over Ethernet (PPPoE) session and even more particularly to minimizing extraneous processing effort during the PPPoE discovery stage.

With the widespread use of broadband technologies, such as digital subscriber lines (DSL, xDSL), cable modems, and wireless devices, mechanisms have been developed to incorporate the always on benefits of a permanent connection with the security benefits of an on-demand, or dial-up, connection. Customer Premise Access Equipment (CPE), including modems, gateways, routers, utilizing always on physical layer technology such as Asynchronous DSL (ADSL) typically have a default configuration that automatically attempts to connect to the remote server, for instance. This can have a significant burden on CPEs, which typically may have relatively limited resources with multiple layers, e.g., physical and network, capability on single chip design.

Point-to Point Protocol (PPP), codified in Request for Comments (RFC) 1548 by the Network Working Group, is a common protocol used to transport data over a physical link and may be considered an OSI network layer protocol. PPP has become the default standard for connecting broadband CPEs to remote access concentrators (e.g., dial-up connections maintained by internet service providers, or ISPs). PPP, as detailed by request for comments (RFC) 1548, describes a process for transporting IP packets over a physical link, incorporating error correction, diagnostics, security, and peer-to-peer negotiation. Likewise, PPP-based protocols, such as the PPP over Ethernet (PPPoE) protocol, the PPP over Asynchronous Transfer Mode (PPPoA) protocol, and the PPP over HDLC protocol, are widely implemented protocols for PPP encapsulation over wide area network (WAN) interfaces.

PPP and PPP-based protocols are particularly useful in communications between network devices on a local area network (LAN) and remote network devices located on a WAN. In such cases, one or more network devices typically are connected to a CPE via any of a number of types of LANs, such as an Ethernet or ATM network. In turn, the CPE is connected to an access concentrator of the WAN via one or more physical network mediums, such as twisted pair cable, coaxial cable, fiber optics, wireless transmission devices, and the like. To transmit data from the network device of the LAN to the remote device on the WAN, a user of a network device typically directs the PPP protocol layer of the CPE to establish a physical transport layer connection (physical connection herein) to the access concentrator over the physical network medium. The physical connection process performed by the PPP stack generally includes providing a user-supplied identification (ID) and password from the CPE to the access concentrator, providing authentication information, receiving notification from the access concentrator that a link is established, and the like. Additionally, the user typically is required to explicitly direct the CPE to initiate the connection process. After the physical connection is established based on user direction, the CPE provides packets from the network device to the access concentrator, and vice versa, over the established physical connection. When the user desires to terminate the connection, the user may direct the CPE to disconnect the physical link with the access concentrator.

PPP over Ethernet (PPPoE) specification, codified in the RFC 2516 specification, has become a dominant standard for connecting broadband customer premise equipment (CPE), such as modems and routers, over a WAN to remote access concentrators, such as Internet service providers (ISPs), by utilizing the high bandwidth of Ethernet in conjunction with the security and traffic-metering afforded by the PPP protocol (defined in the RFC 1548 specification). In general, a PPPoE session includes a discovery stage and a session stage. During the PPPoE discovery stage, a PPPoE client (generally implemented as part of a networking protocol stack) at a host, such as a CPE, negotiates a connection with an access concentrator. After a connection is established in the discovery stage, data can be transferred between the PPPoE client and the access concentrator during the PPPoE session stage. Referring now to FIG. 1, a typical program or routine 100 utilized to implement the PPPoE discovery stage is illustrated (per RFC 2516).

The discovery stage (routine 100) of a PPPoE session typically initiates at step 110, wherein the PPPoE client is initiated, such as when a user on the host loads and executes a dial-up program. At steps 112 and 114, the PPPoE client can initialize and start, respectively, a timer, where the timer is used to set the maximum wait time for a PADO packet. This maximum wait time can vary and often is set for time periods that can exceed 10 seconds in length. At step 120, the PPPoE client generates, using a network protocol stack, a PPPoE Active Discovery Initiation (PADI) packet and then provides the PADI packet to a physical interface for transmission over a network using a broadcast or multicast Ethernet address. The PADI packet is used by the PPPoE client to announce its presence and to determine the existence of any access concentrators on the network(s) to which the PPPoE client is connected. Additionally, the PADI packet can include a tag describing the service requested by the PPPoE client. Upon receipt of the PADI packet, an access concentrator can determine if it is capable of providing the requested service, and if so, reply to the PADI packet by transmitting a PPPoE Active Discovery Offer (PADO) packet to the PPPoE client. The PADO packet is used to indicate that the access concentrator is available and typically includes the unicast address of the access concentrator and one or more tags indicating other services available from the access concentrator.

Accordingly, after transmission of the PADI packet, the PPPoE client waits for one or more PADO packets from one or more access concentrators at step 130. If the PPPoE client receives one or more PADO packets, the discovery stage 100 continues to step 138, wherein the timer is reset for a same or different time period and then started. In this case, the timer is used to set a maximum wait time for a PPPoE active Discovery Session-confirmation (PADS) packet (discussed below).

Otherwise, if at least one PADO packet has not yet arrived by the time that the maximum wait time has elapsed (i.e., the timer has expired) at step 132, the PPPoE client typically sets the timer for a period that is double the previous PADO packet wait time (step 134), and repeats the waiting process of steps 114-134 until either a PADO packet is received or a predetermined number of iterations of steps 114-134 have been performed.

In the event that at least one PADO packet is received before the expiration of the timer, the PPPoE client can examine the one or more PADO packets received and select an appropriate access concentrator. The PPPoE client then transmits a PPPoE Active Discovery Request (PADR) packet at step 140 to the selected access concentrator indicating the service(s) the PPPoE client is requesting. Upon receipt of the PADR packet, the selected access concentrator prepares a PPP session, generates a unique PPP session ID, and provides this session ID to the PPPoE client as part of a PADS packet, which confirms the generation of a PPP session for the PPPoE client by the access concentrator and provides the PPPoE client with the associated session ID.

Prior to sending the PADR packet at step 140, the PPPoE client sets the timer to a maximum wait time for the receipt of a PADS packet from the access concentrator and starts the timer at step 138. Accordingly, after sending the PADR packet at step 140, the PPPoE client waits at step 150 for the receipt of the PADS packet from the access concentrator. If the timer for the PADS packet expires in step 152 without the receipt of a PADS packet, the PPPoE client can assume that the access concentrator is down and/or there is a faulty connection between the PPPoE client and the access concentrator. Based on this assumption, the PPPoE client can initiate the entire PPPoE discovery stage again at step 120 in an attempt to reconnect to the selected access concentrator or to locate an alternate access concentrator. Alternatively, the PPPoE client can retransmit the PADR packet (step 130) and wait again for the PADS packet from the access concentrator (steps 150-152). Otherwise, if a PADS packet is received from the access concentrator at step 150 before the maximum wait time for the PADS packet has expired, the PPPoE client can extract the PPP session ID from the PADS packet and move into the session stage at step 160. In the session stage, the initialization of the PPPoE session is completed, and therefore data can be transmitted between the host and the access concentrator using the PPP session ID.

While PPPoE offers a number of advantages, known implementations of PPPoE can unduly encumber those systems having relatively limited resources. Particularly, attempts at transmitting packets during the discovery stage in the event that the physical layer connection between the host and the access concentrator is down can reduce the efficiency of a system running the PPPoE client.

To illustrate, assume that the host loses the physical layer connection to an access concentrator prior to step 120 or that a physical layer connection has not yet been established. In this case, known implementations of the PPPoE client assume that the always on physical layer connection between the host and the access concentrator is truly always on. Accordingly, these known PPPoE clients attempt to transmit, for example, a PADI packet (step 120) even in the absence of a physical layer connection. Accordingly, the host attempts to transmit the PADI packet for the PPPoE client, thereby consuming valuable system resources as the PADI packet is generated and processed by the layers of the network protocol stack. Additionally, the PPPoE client typically initiates and starts a timer at steps 112, 114 and waits for a PADO packet (steps 130, 132). However, since the PADI packet cannot be transmitted due to the lack of a physical layer connection there cannot be a PADO packet in response. As a result, the timer expires and the PPPoE client then attempts to send the PADI packet again, tying up the host in generating and processing the PADI packet as well as futilely waiting for a PADO packet. This cycle can continue for any number of iterations until the PPPoE client times out the entire discovery stage, resulting in an inefficient use of the resources of the host which otherwise could be applied to other time-sensitive processes. In fact, as discussed above, the wait time for the PADO packet often is doubled each iteration of the waiting period, resulting in an exponential increase in the time the host waits for a PADO packet that cannot arrive over a non-existent physical connection.

At the same time that the PPPoE client is attempting to send out packets to the inaccessible access concentrator, the host typically attempts to establish a physical layer connection with the access concentrator. As a result, the host must share valuable processing bandwidth between the futile attempts at transmission of discovery stage packets and the establishment of a physical layer connection between the host and the access concentrator. Furthermore, this inefficient cycle can occur should the host lose the physical layer connection at other steps of the discovery stage. For example, if the physical layer connection is lost prior to the transmission of a PADR packet at step 140, the host could waste valuable processing time while the PPPoE client repeatedly attempts to transmit a PADR packet and wait for a PADS packet that cannot arrive due to the lost physical layer connection.

While the ineffective operation of a networking protocol stack utilizing such a PPPoE client can severely limit the efficiency of many hosts, those systems with relatively limited resources, such as embedded systems, are particularly affected. Many hosts integrate multiple, time critical processes to achieve lower costs, reduce power consumption, reduce size, and the like. For example, some CPEs, such as network gateways, implement single chip solutions or soft modems that integrate physical layer connectivity (e.g., asynchronous DSL training routines) with networking protocol processes, such as Internet protocol (IP) routing and/or bridging. By implementing multiple processes in a single embedded system, the processing resources of the embedded system often are scarce even during optimal operation. The ability of these embedded systems, as well as many other systems, to perform time-critical functions is further diminished when the system is simultaneously engaged in an attempt to establish, or reestablish, a physical layer connection with an access concentrator and by the PPPoE client in one or more futile attempts to establish a PPPoE session with the inaccessible access concentrator by unsuccessfully transmitting and/or waiting for discovery stage packets.

Furthermore, the PPPoE Specification attempts to address this issue by recommending a host to simply double the waiting period (e.g., step 132) in the event of protocol failure (e.g., at step 130) (see RFC 2516 Section 8). However, this solution is not optimal as it can unnecessarily delay access to the network (in the event of physical connection immediately subsequent to an n-doubled timer expiry) creating the appearance of a defective, or poorly performing host access device.

Accordingly, an improved mechanism for establishing a PPPoE session would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, greater system flexibility, cost savings, etc.

The present invention, in at least one embodiment, improves the efficiency of a host when one or more PPPoE clients are negotiating simultaneously with a physical interface's attempt to establish/synchronize a physical layer connection with an access concentrator. Improved efficiency typically provides more bandwidth for integrated time-critical functions, such as xDSL training, thereby improving the physical layer connectivity. In accordance with one embodiment of the present invention, a method for initializing a PPPoE session between a PPPoE client of a host and an access concentrator during a PPPoE discovery stage is provided. The method comprises the steps of determining, at the PPPoE client, a status of a connection between the host and the access concentrator prior to a transmission of a PPPoE discovery packet and transmitting the PPPoE discovery packet for reception by the access concentrator when the status indicates a physical layer connection is established.

In accordance with another embodiment of the present invention, a method for initializing a PPPoE session between a PPPoE client of a host and an access concentrator during a PPPoE discovery stage is provided. The method comprises the steps of determining, at the PPPoE client, a status of a connection between the host and the access concentrator, and waiting, at the PPPoE client, for a first PPPoE discovery packet from the access concentrator when the status indicates a physical layer connection is established.

In a customer premise access equipment (CPE) having a processor and a physical interface operably connected to the processor and to a transmission medium between the CPE and an access concentrator, a computer readable medium comprising a set of executable instructions is provided in accordance with yet another embodiment of the present invention. The executable instructions are adapted to manipulate the processor to determine a status of a connection between the physical interface and the access concentrator prior to a transmission of a first PPPoE discovery packet and provide the first PPPoE discovery packet to the physical interface for transmission to the access concentrator when the status indicates a physical layer connection is established.

In accordance with an additional embodiment of the present invention, a customer premise access equipment (CPE) is provided. The CPE comprises a physical interface operably connected to a transmission medium between the CPE and an access concentrator and a PPPoE client in bi-directional communication with the physical interface. The PPPoE client is adapted to determine a status of a physical layer connection between the physical interface and the access concentrator over the transmission medium and provide the first PPPoE discovery packet to the physical interface for transmission over the transmission medium to the access concentrator when the status indicates the physical layer connection is established.

In accordance with another embodiment of the present invention, a communications processor for use in a customer premise access equipment (CPE) is provided, the CPE having a physical interface in electrical communication with a transmission medium between the CPE and an access concentrator. The communications processor comprises a network protocol stack and a PPPoE client in bi-directional communication with the physical interface. The PPPoE client is adapted to determine a status of a physical layer connection between the physical interface and the access concentrator over the transmission medium and provide the first PPPoE discovery packet (as well as subsequent discovery packets) to the physical interface for transmission over the transmission medium to the access concentrator when the status indicates the physical layer connection is established.

One advantage of the present invention includes an improved efficiency by minimizing processing effort during a PPPoE discovery stage resulting from a non-established physical layer connection. Another advantage includes a reduction in the time to reach the PPPoE Session stage. Additional advantages may include improved physical layer connection times and connection rates.

Still further features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a flow diagram illustrating a known implementation of a PPPoE discovery stage.

FIG. 2 is a schematic diagram illustrating an exemplary system utilizing a PPPoE client in accordance with at least one embodiment of the present invention.

FIG. 3 is a flow diagram illustrating an exemplary implementation of a PPPoE discovery stage by the exemplary system of FIG. 2 in accordance with at least one embodiment of the present invention.

### DETAILED DESCRIPTION OF THE PREFERRED EMBODIMENTS

The following description is intended to convey a thorough understanding of the present invention by providing a number of specific embodiments and details involving initialization of PPPoE sessions. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

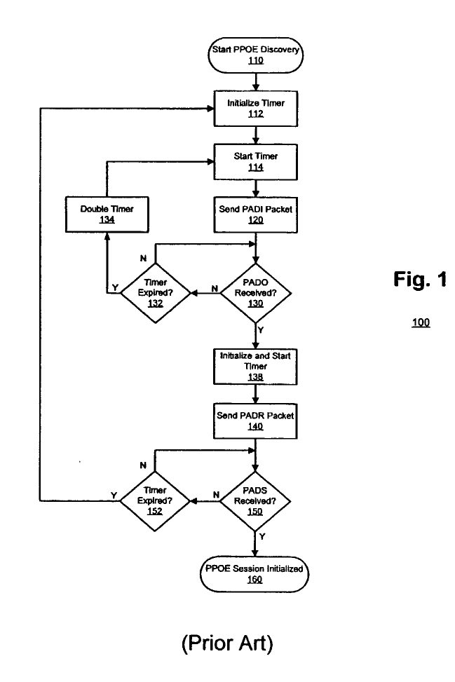

Disclosed herein are various exemplary mechanisms for improved PPPoE initialization between a host and an access concentrator. In at least one embodiment, at one or more points during the PPPoE discovery stage, the PPPoE client determines the status of the physical layer connection between the host and an access concentrator. In the event that a physical layer connection is established, the PPPoE client continues with a typical PPPoE discovery stage process, as outlined above with reference to FIG. 1. In the event that a physical layer connection is not present, the PPPoE client, in one embodiment, is adapted to wait a predetermined amount of time and then recheck for a physical layer connection. By checking for a physical layer connection prior to attempting to transmit a PPPoE discovery packet (i.e., a PADI or PADR packet) and/or wait for a PPPoE discovery packet (i.e., a PADO or PADS packet) from an access concentrator, the PPPoE client can free up the resources of the host to perform other time-critical processes, such as establishing the physical layer connection, in the event that a physical layer connection is not established.

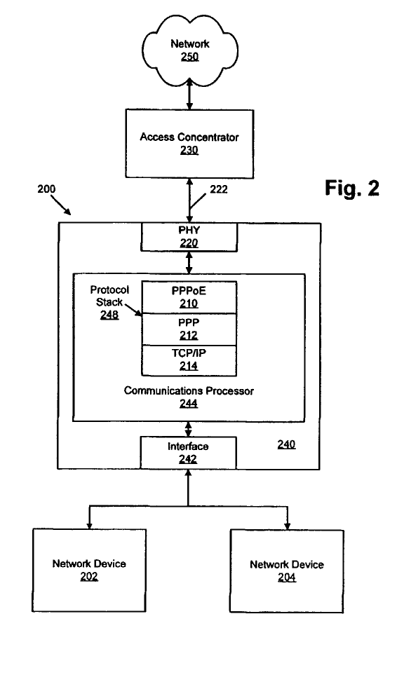

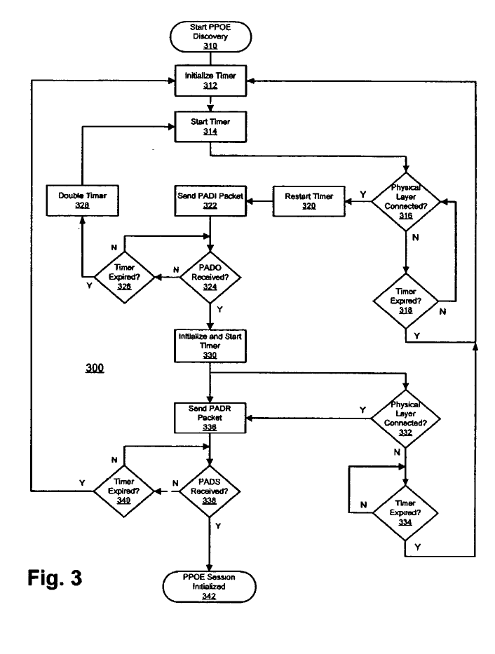

Referring now to FIGS. 2 and 3, an exemplary system and routine for improving the efficiency of the PPPoE discovery stage is illustrated in accordance with at least one embodiment of the present invention. FIG. 2 illustrates an exemplary broadband system 200 utilizing PPPoE and FIG. 3 illustrates an exemplary routine 300 used by the system 200 during the PPPoE discovery stage. The functionality of routine 300 may be accomplished in whole or in part or in combination by software and/or hardware. The illustrated system 200 comprises one or more network devices 202, 204 (e.g., a networked desktop computer), a CPE 240, such as a network gateway (e.g., a digital subscriber line xDSL modem), connected to an access concentrator 230 via a transmission medium 222. The access concentrator 230, in turn, is connected to a network 250 or combination of networks, such as a wide area network (WAN), a local area network (LAN), a wireless network, the Internet, and the like.

The CPE 240 includes a network interface 242, a communications processor 244, and a physical layer interface (PHY) 220. The network interface 242 can include any of a variety of network interfaces, such as an Ethernet or USB interface. Any of a variety of types of transmission mediums may be implemented by transmission medium 222, such as twisted pair wiring, coaxial cable, fiber optics, and the like. Accordingly, the PHY 220 can include a physical interface appropriate to the transmission medium 222. For example, the transmission medium 222 can include the plain old telephone system (POTS). In this case, the PHY 220 can include a UTOPIA ATM Cell interface. Alternatively, the transmission medium can include a fiber optic channel. In this case, the PHY 220 could include an electrical/optical transceiver. Furthermore, the PHY 220 can include a wireless transceiver. The communications processor 244 can include any of a variety of processing devices that can be adapted to process data for communications purposes, such as an microprocessor, a microcontroller, an application specific integrated circuit (ASIC), a programmable logic device (PLD), and the like. For example, the communication processor 244 can include a communications processor available under the trade name Beryllium from GlobespanVirata, Inc. of Red Bank, N.J.

In the illustrated embodiment, the CPE 240 is utilized to provide bi-directional communication between one or more network devices 202, 204 and to the network 250 via the access concentrator 230. To facilitate the transfer of data to and from the access concentrator 230, in at least one embodiment, the CPE 240 is adapted to support one or more PPPoE sessions with the access concentrator 230 using a PPPoE client 210. In the illustrated embodiment, the PPPoE client 210 is implemented as part of a networking protocol stack 248, such as a Transmission Control Protocol/Internet Protocol (TCP/IP) stack having a TCP/IP layer 214, a PPP layer 212 and the PPPoE client 210, as well as other network layers as appropriate. The network protocol stack 248 is used by the communications processor 244 to process incoming and outgoing network data. In this case, the network protocol stack 248 can be implemented in software, hardware, firmware, or a combination thereof. However, in other embodiments, the PPPoE client 210 can be implemented as a separate software application on the CPE 240, as a PPPoE client at one of network devices 202, 204, and the like. As discussed above, PPPoE includes two stages, the discovery stage to establish a PPPoE session and the session stage to transmit/receive network data over the established PPPoE session. FIG. 3 illustrates an exemplary discovery routine 300 that can be utilized by the PPPoE client 210 to implement the discovery stage. The discovery routine 300 initiates with step 310, wherein the communications processor 244, via the networking protocol stack 248, directs the PPPoE client 210 to establish a PPPoE session with the access concentrator 230 on behalf of itself 248, or one of the network devices 202, 204. However, unlike the known PPPoE discovery stage (routine 100, FIG. 1) whereby the transmission of a PPPoE discovery packet is attempted (for example, a transmission of a PADI packet at step 120, FIG. 1) without regard to the status of the physical layer connection, the discovery routine 300, in one embodiment, determines the status of the connection between the CPE 240 and the access concentrator 230 (i.e., the physical connection) prior to any attempt at providing a PPPoE discovery packet to the PHY 220 for transmission to the access concentrator 230. Additionally, or alternatively, the discovery routine 300 can be adapted to determine the status of the physical connection prior while waiting for a PPPoE discovery packet from the access concentrator 230. If the physical connection is not established, no discovery packet can be received, so the discovery routine 300 can direct the CPE 240 to attempt to reestablish a physical connection with the access concentrator 130 and restart the PPPoE discovery stage.

To illustrate, prior to generating and transmitting a PADI packet (step 322), the PPPoE client 210, in one embodiment, is adapted to initialize a timer at step 312 with a time period representative of a maximum wait time for the establishment of a physical connection and start the timer at step 314. At step 316, the CPE 240 is adapted to determine the status of the connection. Based on the status of the physical layer connection, the PPPoE client 210 can continue with the generation and transmission of the PADI packet when the physical layer connection is established or delay the generation/transmission for a predetermined amount of time to allow the CPE 240 time to attempt to establish a physical layer connection.

Any of a number of mechanisms may be used to determine the status (i.e., established or not established) of the physical layer connection. For example, in one embodiment, the communications processor 244 implements a software interface adapted to monitor the status of the PHY 220. This can be accomplished by, for example, using a software attribute of the device driver used to control the interface 242, where the attribute is updated by the PHY 220. The upper layers of the protocol stack 248 then can monitor this attribute to determine the status of the PHY 220. When the physical layer connection is established, the PHY 220 modifies a connection attribute of the software interface associated with the PHY 220 to reflect the connected status of the physical layer connection maintained by the PHY 220. Conversely, when the physical layer connection is lost or down, the PHY 220 can change the connection attribute of the software interface to reflect that a physical layer connection is not established by the PHY 220.

The PPPoE client 210 can determine the appropriate value for the connection status by, for example, polling the PHY 220 or the PHY 220 can signal PPPoE 210 whenever the physical layer connection changes states. The signaling mechanism may be by any technique supported in CPE 240, such as via an interrupt or an inter-process communications message (as a function of an operating system of processor 244). The PPPoE client 210 then can determine the status of the physical layer connection by querying the software interface. The software interface, in one embodiment, includes a generic software interface that can be utilized with a variety of physical interfaces.

Alternatively, the PPPoE client 210 can be adapted to directly query the PHY 220 to determine the status of the physical layer connection over the transmission medium 222, or the PHY 220 can provide a signal, such as an interrupt, representative of its status to the processor 244 for use by the PPPoE client 210 to determine the status of the physical layer connection. In either case, the PPPoE client 210 can be adapted to perform the physical layer check independently of the higher-level layers (e.g., IP or PPP) and the lower-level layers, such as ATM Adaptation Layer 5 (AAL5), of the network protocol stack 248. As a result, the PPPoE client 210 can be integrated with standardized higher-level and lower level protocol layers in a variety of network protocol stacks. Likewise, by compartmentalizing the physical layer check entirely within the PPPoE client 210, overall system exposure can be reduced. Alternatively, in another embodiment, a lower layer of the networking protocol stack, such as the AAL5 protocol layer, can be adapted to provide an indicator of the connection status of the PHY 220. Although exemplary mechanisms for determining the status of the physical layer connection have been disclosed, those skilled in the art can devise other mechanisms using the guidelines provided herein.

If the PPPoE client 210 determines at step 316 that the physical layer connection is down, the PPPoE client 210, in at least one embodiment, delays or cancels the generation and/or provision of the PADI packet to the PHY 220. If the generation and/or transmission of the PADI packet is delayed, the PPPoE client 210 can periodically check the status of the physical layer connection (step 316) by, for example, restarting the timer at steps 312-314 with an initial wait time value (e.g., the maximum wait time for receiving the PADO packet) and rechecking the physical connection status (step 316) each time the timer expires (step 318). Steps 312-318 can be performed repeatedly until the physical layer connection is established/reestablished. Alternatively, the steps 316-318 can be repeated for up to a predetermined maximum number of iterations. The time between iterations can be constant, linearly increased, geometrically increased, exponentially increased (i.e., doubled), randomly selected, and the like. When the predetermined number of iterations has been performed, the PPPoE client 210 may conclude that the PHY 220 is having difficulty in establishing the physical layer connection. Accordingly, the PPPoE client 210 can be adapted to signal the communications processor 244 of the failed attempt to establish a PPPoE session with the access concentrator 230.

The initial time value of the timer set in step 312 can be predetermined based at least in part on any number of factors. One factor can include the typical time needed to establish/reestablish the physical layer connection between the PHY 220 and the access concentrator 230. For example, the PHY 220 could include a DSL PHY interface, such as a UTOPIA II interface, and the access concentrator 230 could include a DSL access multiplexer (DSLAM). The establishment of a physical layer connection between a Utopia II interface and a DSLAM often ranges from 15-60 seconds. Accordingly, the initial time value of the timer could be set to a value ranging from fifteen to sixty seconds or more, thereby allowing the PHY 220 enough time to establish/reestablish the physical layer connection before checking the status again.

By using the timer at steps 312-318 to delay the next attempt at generating/transmitting the PADI packet in the event that a physical connection is not established, the PPPoE client 210 can allow the host to more effectively allocate its resources to other processes, such as establishing the physical layer connection over the transmission medium 222 or handling data between network devices 202 and 204, rather than spending processing time and effort on one or more futile attempts to transmit the PADI packet to the access concentrator 230 in the absence of an established physical layer connection. As such, the communications processor 244 can react more quickly to other time-sensitive processes, such as DSL modem training, without otherwise degrading the performance of the PPPoE client 210 since the physical layer connection is unavailable.

In the event that a physical layer connection is established/reestablished sometime before an initial or successive iteration of steps 312-318, the PPPoE client 210 can detect the established status of the physical layer connection and proceed with the transmission of a PADI packet at step 322 by providing the PADI packet to the PHY 220 for transmission to the access concentrator 230 over the transmission medium 222. Prior to transmitting the PADI packet (or after sending the PADI packet) at step 322, the PPPoE client 210, in one embodiment, is adapted to set reset the timer to a same or different wait time at step 320, where the wait time set at step 320 can be a same or different wait time than the wait time of the timer set at step 314.

At step 324 (analogous to step 130, FIG. 1), the PPPoE client 210 waits for at least one PADO packet sent by the access concentrator in response to the PADI packet sent at step 322. If a PADO packet has not arrived by before the timer expires at step 326, in one embodiment, it may be assumed that the access concentrator 230 is busy, or not accepting PPPoE requests. Accordingly, the timer is reset (step 328, analogous to step 134, FIG. 1) and restarted at step 314. The wait time of the timer set at step 328 preferably is approximately double the wait time of a previous iteration of step 328 (as suggested by RFC 2516 Section 8). Alternatively, the wait time can be constant; increased geometrically, linearly, or exponentially; selected at random; and the like. Some or all of steps 314-328 are repeated up to a predetermined number of iterations until a logical connection is made to the access concentrator 230 (step 324) (i.e., a PADI packet is sent (step 322) and a PADO packet is received (step 130) before the timer expires (step 326).

If and when a PADO packet is received at step 324 prior to an expiration of the timer, the routine 300 continues, in one embodiment, to step 336 (analogous to step 140, FIG. 1) wherein a PADR packet is transmitted in response to the receipt of the PADO packet, as discussed above. In one embodiment, the routine 300 continues to step 338 (analogous to step 150, FIG. 1), whereupon the PPPoE client 210 waits for a PADS packet from the access concentrator 230. Prior to (or after) sending the PADR packet at step 336, the PPPoE client 210 can be adapted to set the timer with a time period representing the maximum wait time for the PADS packet from the concentrator. If the timer expires at step 340 (analogous to step 152, FIG. 1) prior to receiving the PADS packet, the PPPoE client 210 may assume that the physical connection is disconnected. The PPPoE client 210 then can attempt to reestablish the physical connection by repeating some or all of the previous steps 312-338. Otherwise, upon receipt of a PADS packet from the concentrator 230, the PPPoE discovery stage concludes and the PPPoE client 210 enters the PPPoE session stage at step 342.

The PPPoE client 210 can be adapted to perform a physical layer connection check (described in steps 312-318 and steps 330-334) prior to waiting for any or all PPPoE discovery packets (i.e., a PADO or PADS packet) from the access concentrator 230. Accordingly, the wasted processor effort resulting from the wait for undeliverable packets from the access concentrator 230 when the physical layer connection is down can be substantially minimized or eliminated.

To illustrate, after receiving a PADO packet (step 324) and prior to sending the PADR packet (336), rather than proceeding directly to step 338, the PPPoE client 210 can initialize and start the timer at step 330 and determine the status of the physical layer connection at step 332. If the physical layer connection is still established, then the PPPoE client 210 could continue to step 336 wherein the PPPoE client 210 provides the PADR packet to the PHY 220 for transmission to the access concentrator 230. If the physical layer connection is down (i.e., not established), then the PPPoE client 210 could wait until the timer set at step 330 expires, thereby freeing the processor 244 to perform other tasks in the interim. When the timer expires (step 334), the PPPoE client 210 can query the PHY 220 to determine the status of the physical layer connection. If the physical layer connection is not established after a certain number of iterations of steps 332-334, the PPPoE client 210 can start the PPPoE discovery stage anew at step 312 in an attempt to reestablish a physical connection and/or the PPPoE client 210 could contact other components of the CPE 240 to indicate that an attempt to establish a PPPoE session has failed. Accordingly, wasted processing time and effort resulting attempts to transmit a PPPoE discovery packet over a physical layer connection that is not established can be minimized or eliminated. If a physical layer connection is established, the PPPoE client 210 can continue to step 338-342 as described above. Additionally, or alternatively, the physical connection check described in steps 312-318 and steps 330-334 can be performed after sending the PADI packet (step 322) and/or after sending the PADR packet (step 336).

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

What is claimed is:

1. A method for initializing a PPPoE session between a PPPoE client of a host and an access concentrator during a PPPoE discovery stage, the method comprising the steps of:
determining, at the PPPoE client, a status of a connection between the host and the access concentrator prior to a transmission of a PPPoE discovery packet; and
transmitting the PPPoE discovery packet for reception by the access concentrator when the status indicates a physical layer connection is established.

2. The method of claim 1, further comprising the step of delaying the transmission of the PPPoE discovery packet for a predetermined time period when the status indicates a physical layer connection is not established.

3. The method of claim 2, wherein the predetermined time period is one of a group consisting of: a constant time period, a random time period, a linearly increasing time period, and an exponentially increasing time period.

4. The method of claim 2, further comprising the step of attempting to establish a physical layer connection between the host and the access concentrator when the status indicates a physical layer connection is not established.

5. The method of claim 1, further comprising the step of attempting to establish a physical layer connection between the host and the access concentrator when the status indicates a physical layer connection is not established.

6. The method of claim 1, wherein the step of determining the status of the physical layer connection includes querying a physical interface in electrical communication with a transmission medium between the host and the access concentrator.

7. The method of claim 6, wherein the step of querying the physical interface includes querying a software interface adapted to monitor a status of the physical interface.

8. The method of claim 1, wherein the PPPoE discovery packet includes one of a group consisting of: a PADI packet and a PADR packet.

9. The method of claim 1, further comprising the step of generating the PPPoE discovery packet when the status indicates a physical layer connection is established.

10. A method for initializing a PPPoE session between a PPPoE client of a host and an access concentrator during a PPPoE discovery stage, the method comprising the steps of:
determining, at the PPPoE client, a status of a connection between the host and the access concentrator; and
waiting, at the PPPoE client, for a first PPPoE discovery packet from the access concentrator when the status indicates a physical layer connection is established.

11. The method of claim 10, further comprising the step of terminating the PPPoE discovery stage when the status indicates a physical layer connection is not established.

12. The method of claim 10, further comprising the step of attempting to establish a physical layer connection between the host and the access concentrator when the status indicates a physical layer connection is not established.

13. The method of claim 10, further comprising the step of transmitting a second PPPoE discovery packet for reception by the access concentrator when the status indicates a physical layer connection is established.

14. The method of claim 13, further comprising the step of delaying a transmission of the second PPPoE discovery packet for a predetermined time period when the status indicates a physical layer connection is not established.

15. The method of claim 14, wherein the predetermined time period is one of a group consisting of: a constant time period, a random time period, a linearly increasing time period, and an exponentially increasing time period.

16. The method of claim 13, further comprising the step of generating, at the PPPoE client, the second PPPoE discovery packet when the status indicates a physical layer connection is established.

17. The method of claim 13, wherein the second PPPoE discovery packet includes one of a group consisting of: a PADI packet and a PADR packet.

18. The method of claim 10, wherein the step of determining the status of the physical layer connection includes querying a physical interface in electrical communication with a transmission medium between the host and the access concentrator.

19. The method of claim 10, wherein the step of querying the physical layer interface includes querying a software interface adapted to monitor a status of the physical interface.

20. The method of claim 10, wherein the first PPPoE discovery packet includes one of a group consisting of: a PADO packet and a PADS packet.

21. In a customer premise access equipment (CPE) having a processor and a physical interface operably connected to the processor and to a transmission medium between the CPE and an access concentrator, a computer readable medium comprising a set of executable instructions adapted to manipulate the processor to:
determine a status of a connection between the physical interface and the access concentrator prior to a transmission of a first PPPoE discovery packet; and
provide the first PPPoE discovery packet to the physical interface for transmission to the access concentrator when the status indicates a physical layer connection is established.

22. The computer readable medium of claim 21, further comprising executable instructions adapted to manipulate the processor to delay the provision of the first PPPoE discovery packet to the physical interface for a predetermined time period when the status indicates a physical layer connection is not established.

23. The computer readable medium of claim 21, wherein the predetermined time period is one of a group consisting of: a constant time period, a random time period, a linearly increasing time period, and an exponentially increasing time period.

24. The computer readable medium of claim 21, further comprising executable instructions adapted to manipulate the processor to direct the physical interface to establish a physical layer connection between the CPE and the access concentrator when the status indicates a physical layer connection is not established.

25. The computer readable medium of claim 21, further comprising executable instructions adapted to manipulate the processor to direct the physical interface to establish a physical layer connection between the CPE and the access concentrator when the status indicates a physical layer connection is not established.

26. The computer readable medium of claim 21, wherein the executable instructions are adapted to manipulate the processor to determine the status of the physical layer connection include executable instructions adapted to manipulate the processor to query the physical interface.

27. The computer readable medium of claim 26, wherein the executable instructions adapted to manipulate the processor to query the physical interface include executable instructions adapted to manipulate the processor to query a software interface for monitoring a status of the physical interface.

28. The computer readable medium of claim 21, wherein the first PPPoE discovery packet includes one of a group consisting of: a PADI packet and a PADR packet.

29. The computer readable medium of claim 21, further comprising executable instructions adapted to manipulate the processor to wait for a second PPPoE discovery packet from the access concentrator when the status indicates a physical layer connection is established.

30. The computer readable medium of claim 29, wherein the second PPPoE discovery packet includes one of a group consisting of: a PADO packet and a PADS packet.

31. The computer readable medium of claim 21, further comprising executable instructions adapted to manipulate the processor to terminate a PPPoE discovery stage when the status indicates the physical layer connection is not established.

32. The computer readable medium of claim 21, further comprising executable instructions adapted to manipulate the processor to generate the first PPPoE discovery packet when the status indicates a physical layer connection is established.

33. The computer readable medium of claim 21, wherein the set of executable instructions is implemented as part of a network protocol stack.

34. A customer premise access equipment (CPE) comprising:
a physical interface operably connected to a transmission medium between the CPE and an access concentrator; and
a PPPoE client in bi-directional communication with the physical interface and being adapted to:
determine a status of a physical layer connection between the physical interface and the access concentrator over the transmission medium; and
provide the first PPPoE discovery packet to the physical interface for transmission over the transmission medium to the access concentrator when the status indicates the physical layer connection is established.

35. The CPE of claim 34, wherein the PPPoE client is further adapted to delay the provision of the first PPPoE discovery packet to the physical interface for a predetermined time period when the status indicates a physical layer connection is not established.

36. The CPE of claim 35, wherein the predetermined time period is one of a group consisting of: a constant time period, a random time period, a linearly increasing time period, and an exponentially increasing time period.

37. The CPE of claim 34, wherein the PPPoE client is further adapted to query the physical interface to determine the status of the physical layer connection.

38. The CPE of claim 34, further including a software interface in communication with the physical interface and the PPPoE client and being adapted to monitor a status of the physical interface, and wherein the PPPoE client is further adapted to query the software interface to obtain the status of the physical interface.

39. The CPE of claim 34, wherein the first PPPoE discovery packet includes one of a group consisting of: a PADI packet and a PADR packet.

40. The CPE of claim 34, wherein the PPPoE client is further adapted to wait for a second PPPoE discovery packet from the access concentrator when the status indicates a physical layer connection is established.

41. The CPE of claim 40, wherein the second PPPoE discovery packet includes one of a group consisting of: a PADO packet and a PADS packet.

42. The CPE of claim 34, wherein the PPPoE client is further adapted to terminate a PPPoE discovery stage when the status indicates the physical layer connection is not established.

43. The CPE of claim 34, wherein the PPPoE client is further adapted to generate the first PPPoE discovery packet when the status indicates a physical layer connection is established.

44. The CPE of claim 34, wherein the PPPoE client is implemented as part of a network protocol stack.

45. A communications processor for use in a customer premise access equipment (CPE), the CPE having a physical interface in electrical communication with a transmission medium between the CPE and an access concentrator, the processor comprising:
a network protocol stack; and
a PPPoE client in bi-directional communication with the physical interface and being adapted to:
determine a status of a physical layer connection between the physical interface and the access concentrator over the transmission medium; and
provide the first PPPoE discovery packet to the physical interface for transmission over the transmission medium to the access concentrator when the status indicates the physical layer connection is established.

46. The communications processor of claim 45, wherein the PPPoE client is further adapted to delay the provision of the first PPPoE discovery packet to the physical interface for a predetermined time period when the status indicates a physical layer connection is not established.

47. The communications processor of claim 46, wherein the predetermined time period is one of a group consisting of: a constant time period, a random time period, a linearly increasing time period, and an exponentially increasing time period.

48. The communications processor of claim 45, wherein the PPPoE client is further adapted to query the physical interface to determine the status of the physical layer connection.

49. The communications processor of claim 45, wherein a software interface is in communication with the physical interface and the PPPoE client and is adapted to monitor a status of the physical interface, and the PPPoE client is further adapted to query the software interface to obtain the status of the physical interface.

50. The communications processor of claim 45, wherein the first PPPoE discovery packet includes one of a group consisting of: a PADI packet and a PADR packet.

51. The communications processor of claim 45, wherein the PPPoE client is further adapted to wait for a second PPPoE discovery packet from the access concentrator when the status indicates a physical layer connection is established.

52. The communications processor of claim 51, wherein the second PPPoE discovery packet includes one of a group consisting of: a PADO packet and a PADS packet.

53. The communications processor of claim 45, wherein the PPPoE client is further adapted to terminate a PPPoE discovery stage when the status indicates the physical layer connection is not established.

54. The communications processor of claim 45, wherein the PPPoE client is further adapted to generate the first PPPoE discovery packet when the status indicates a physical layer connection is established.

55. The communications processor of claim 45, wherein the PPPoE client is implemented as part of the network protocol stack.
